(19) United States
(12) Patent Application Publication
(10) Pub. No.: US 2016/0026958 A1
(43) Pub. Date: Jan. 28, 2016

(54) RESTAURANT FOOD PREPARATION SCHEDULING MANAGEMENT SYSTEM AND METHOD

(71) Applicant: National Kaohsiung First University of Science and Technology, Kaohsiung City (TW)

(72) Inventor: Ching-Chang LEE, Kaohsiung City (TW)

(21) Appl. No.: 14/734,510

(22) Filed: Jun. 9, 2015

(30) Foreign Application Priority Data
Jul. 25, 2014 (TW) 103125525

(51) Int. Cl. G06Q 10/06

(52) U.S. Cl. CPC G06Q 10/06316; G06Q 50/12

(57) ABSTRACT

A restaurant food preparation scheduling management system and method are provided. The system comprises: a food ordering module, used to input food ordering data, where the food ordering data includes a plurality of pieces of dish data; a storage module, used to record category data of the dish data; a categorization module, connected to the storage module and the food ordering module, and used to categorize the dish data in the food ordering data into categories according to the category data; a scheduling processing unit, used to take the dish data of the same category as a food preparation group according to the category data of the dish data, so as to set up a food preparation scheduling list; and a food preparation device, to which the food preparation scheduling list is transmitted, used to display the food preparation scheduling list.

### BACKGROUND

This application claims the benefit of Taiwan Patent Application No. 103125525, filed on Jul. 25, 2014, which is hereby incorporated by reference for all purposes as if fully set forth herein.

### TECHNICAL FIELD

The present invention relates to a scheduling control and management system and method, and particularly, to a scheduling manner for food preparation after food ordering in a restaurant, where the system first receives food ordering information, then categorizes the information and finally performs a scheduling operation. More particularly, the present invention relates to an automatic scheduling method and automatic scheduling steps.

Related Art

In recent years, more and more people eat out, and diversity and competitive pressure of a restaurant are increased accordingly. For a restaurant owner, in addition to the taste and the price of food, the quality of the provided food and the food serving speed are also important factors which common people take into consideration during selection of restaurants.

Currently, a solid invention foundation has been laid for a restaurant food ordering system. It is common and universal that a food ordering device is used to transmit information to a background for a basic food preparation process, and some technologies of the food ordering device already exist in the prior art to meet the basic demands for food ordering. However, because the complexity of the food preparation processes is high in some restaurants and a great difference exists therebetween, there is still room for improvement in automation technologies of the food preparation process. When the restaurant provides a diversity of food and the food ordering data is transmitted to the background to perform a management process of a food preparation procedure, if only a simple working mode such as first in first out is used for scheduling, the procedure may be repeatedly processed when one piece of food ordering information is only handled at a time; in addition, when the restaurant receives a large number of orders at the same time and repeated food is ordered subsequently, the customers who order the food later may wait too long and other problems may be caused.

Further, when an unforeseen incident occurs, such as the customer wants to change or cancel the food ordering information, or when the customer raises other special demands, in such situation that usually happens in the restaurant food preparation process, the usual way is to manually change the food ordering information, which causes an increased error rate; furthermore, when the shortage of the provided food is coming, the latest new food ordering information is provided to the customer in time, and the accuracy in food ordering can also be improved.

Therefore, how to provide a system and a method for properly managing the food preparation scheduling in a restaurant, which can reduce the cost in procedure repetition, ensure the food quality, improve the food serving speed, and reduce the error rate, so that the restaurant food preparation process tends to be automated, is a problem to be solved in the prior art.

### SUMMARY

In view of the problem in the prior art, an objective of the present invention is to provide a restaurant food preparation scheduling management system and method, which can improve a restaurant food preparation process and a manner of updating food preparation scheduling, and especially, automatically adjust a scheduling sequence by means of the food preparation process so as to improve the restaurant food preparation efficiency, meet requirements of a restaurant owner by customizing restrictions on the time and the quantity of food preparation scheduling, accelerate the food serving speed, and ensure the quality of the served food.

A restaurant food preparation scheduling management system provided by the present invention comprises: a food ordering module, used to input food ordering data, where the food ordering data comprises a plurality of pieces of dish data; a storage module, used to record category data of the dish data; a categorization module, connected to the storage module and the food ordering module, and used to categorize the dish data in the food ordering data into categories according to the category data; a scheduling processing unit, used to take the dish data of the same category as a food preparation group according to the category data of the dish data, so as to set up a food preparation scheduling list; and a food preparation device, used to obtain and display the food preparation scheduling list.

Further, a restaurant food preparation scheduling management method provided by the present invention comprises: inputting, by a food ordering module, food ordering data, where the food ordering data comprises a plurality of pieces of dish data; categorizing, by a categorization module, the dish data in the food ordering data into categories according to category data; taking, by a scheduling processing unit, the dish data of the same category as a food preparation group according to the category data of the dish data, so as to set up a food preparation scheduling list; and obtaining and displaying, by a food preparation device, the food preparation scheduling list.

The present invention provides a categorization manner in restaurant food preparation scheduling and a manner of automatically updating the scheduling. The present invention can improve a management manner in the quantity and the time in a restaurant food preparation process, improve the efficiency of the restaurant food preparation process, avoid an error and a dispute caused due to manual processing in the prior art, and ensure timing accuracy in the food preparation process, thereby reducing the waste of operating resource cost such as the labor cost and the food material cost.

To make the architecture, features, and functions of the present invention more comprehensible to the examiner, the present invention is described in detail in the following with reference to the accompanying drawings and the specific embodiments.

### BRIEF DESCRIPTION OF THE DRAWINGS

The disclosure will become more fully understood from the detailed description given herein below for illustration only, and thus are not limitative of the disclosure, and wherein:

FIG. 1 is a schematic block diagram of elements of a system according to the present invention;

FIG. 2 is a schematic block diagram of elements of another system according to the present invention;

FIG. 3 is a schematic flowchart of a method according to the present invention;

FIG. 4A is a schematic diagram showing processing on food ordering data according to the present invention; and

FIG. 4B is a schematic diagram showing a time sequence of processing on food ordering data according to the present invention.

### DETAILED DESCRIPTION

Embodiments of the present invention are described in detail below with reference to the accompanying drawings, so that the present invention is more comprehensible.

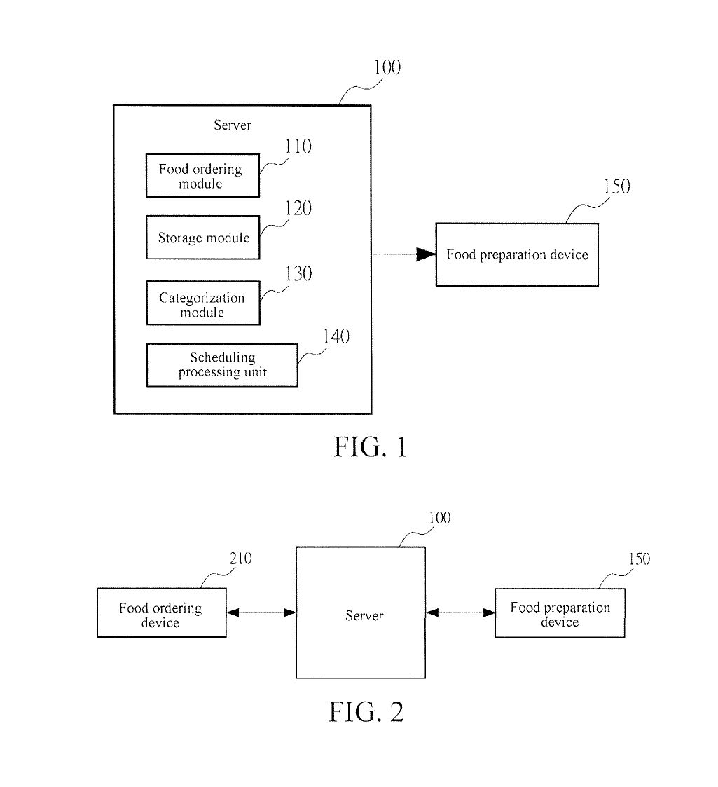

FIG. 1 is a schematic block diagram of elements of a restaurant food preparation scheduling management system according to the present invention, and is a system architecture diagram according to a preferred embodiment. The system mainly includes a server 100, a food ordering module 110, a storage module 120, a categorization module 130, a scheduling processing unit 140, and a food preparation device 150.

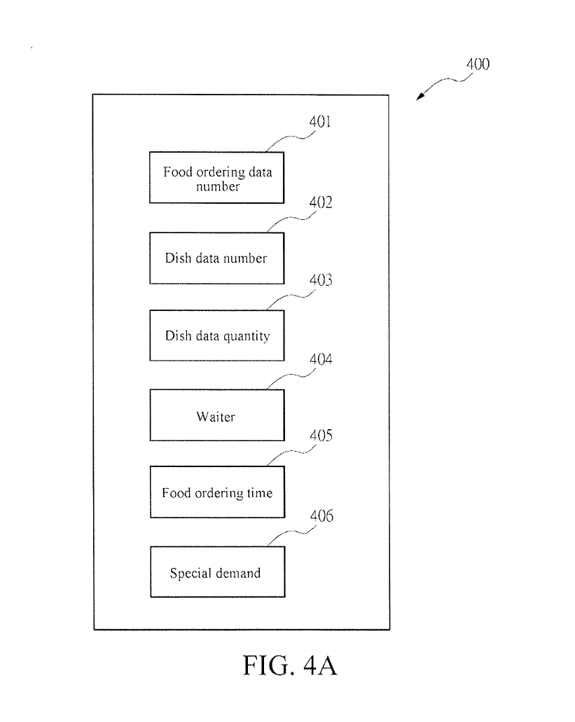

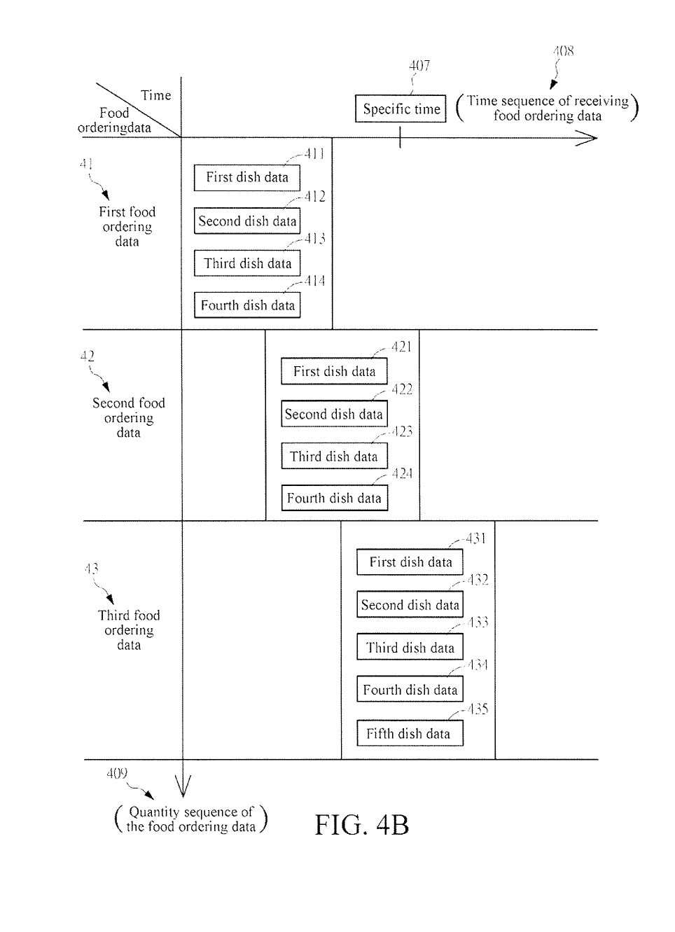

Referring to FIG. 4A and FIG. 3, the food ordering module 110 is used to input different food ordering data 400 such as first food ordering data 41, second food ordering data 42, and third food ordering data 43, and each piece of the food ordering data 400 may include a plurality of pieces of dish data 4020 (Step S301), where a dish data number 402 in the food ordering data is used to distinguish the different dish data, and record a corresponding dish data quantity 403 which is greater than or equal to 1; the system automatically records food ordering time 405, and can also input the food ordering data in advance, and customize the food ordering time 405 of the food ordering data, and the name or another identification manner of a waiter 404; and the system also provides a special demand 406 on the food ordering data 400 input by the waiter.

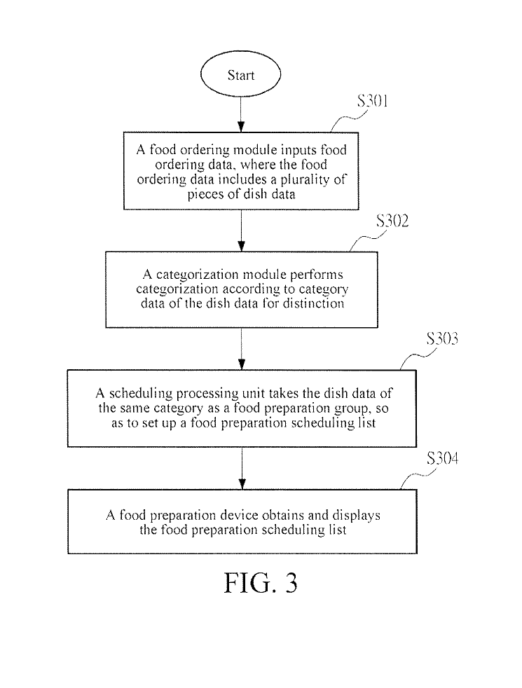

According to another specific embodiment of the present invention, referring to FIG. 2, the server 100 may be externally connected to a food ordering device 210, used to return the food ordering data 400 to the server 100, where the food ordering device 210 may be a portable electronic device and have an application corresponding to the food ordering module, such as a software program or an APP, can display the food ordering data 400, enable the waiter 404 to record the food ordering data 400 such as the dish data 4020, the dish data quantity 403, and the special demand 406, and return the food ordering data 400, and other related food ordering data 400 such as the food ordering time 405 and the waiter 404 to the food ordering module 110 corresponding to the server 100 through a wired or wireless network.

Referring to FIG. 3 together, the storage module 120 records category data of the dish data 4020, and the category data is obtained by categorizing the dish data 4020 of the restaurant according to a required cooking process or practice (Step S302), such as food material cleaning, seasoning preparation, cooking manners, and food serving combination. For example, within a same time interval in a restaurant, different food ordering data 400 includes the same dish data 4020: Caesar salad, such dish data having the same food preparation manner is taken as the same category data, and the food ordering data is transmitted to the scheduling processing unit 140. For another example, a Chinese restaurant is about to serve two dishes: sweet and sour chicken and Taiwanese style fried chicken, and their cooking manners are the same, namely, frying. Therefore, the process of frying the chicken of the required total quantity is considered as the same category data, and then other cooking processes follow after the process is completed. For still another example, in a steaming area, the cooking manner of steaming the dish data 4020 is considered as the same category data, and the same dish data 4020 may be directly considered to have the same category data.

In addition, the storage module 120 records a preset quantity of all dish data 4020 that the restaurant can serve currently, and when a total quantity of the dish data 4020 in the food ordering data input by the food ordering module exceeds the quantity that the restaurant can serve, information is output to the food ordering device 210 or is displayed on the system to prompt the waiter that correction needs to be performed.

Referring to FIG. 3 together, the storage module 120 records specific time 407, and the scheduling processing unit 140 takes the specific time 407 as batch processing time. Referring to FIG. 4B, a horizontal axis represents a time sequence 408 of receiving the food ordering data, where the specific time 407 may be any point on the horizontal axis, which is predetermined by the system or customized by a user; and the dish data 4020 of the same category is taken as a food preparation group 141 according to category data of the dish data 4020 that is recorded in the food ordering data 400 received within the specific time 407 corresponding to each scheduling batch, so as to set up a food preparation scheduling list 142; or dish data included in subsequent food ordering data is updated to the food preparation scheduling list 142 according to category data of the dish data (Step S303).

Referring to FIG. 3 together, the storage module 120 records a food ordering data quantity 409, which indicates a total quantity of the food ordering data 400 received by the scheduling processing unit 140. Referring to FIG. 4B, a vertical axis represents a quantity sequence 410 of the received food ordering data, which is arranged according to the sequence of the food ordering data. As shown in FIG. 4B, the first food ordering data 41 includes first dish data 411 of the first food ordering data, second dish data 412 of the first food ordering data, third dish data 413 of the first food ordering data, and fourth dish data 414 of the first food ordering data; the second food ordering data 42 includes first dish data 421 of the second food ordering data, second dish data 422 of the second food ordering data, third dish data 423 of the second food ordering data, and fourth dish data 424 of the second food ordering data; and the third food ordering data 43 includes first dish data 431 of the third food ordering data, second dish data 432 of the third food ordering data, third dish data 433 of the third food ordering data, fourth dish data 434 of the third food ordering data, and fifth dish data 435 of the third food ordering data. The food ordering data quantity 409 may be any point on the vertical axis, which is predetermined by the system or customized by the user; and when the food ordering data quantity 409 does not reach a set value, the scheduling processing unit 140 takes the dish data 4020 of the same category as the food preparation group 141 according to the category data of the dish data 4020, so as to set up a food preparation scheduling list 142, or updates the dish data 4020 included in the subsequent food ordering data to the food preparation scheduling list 142 according to the category data of the dish data (Step S303).

Referring to FIG. 3 together, the storage module 120 records food preparation batch time corresponding to each piece of the dish data 4020; the food preparation batch time may be predetermined by the system or customized by the user, and used to indicate batch processing time corresponding to different quantities of the dish data; and the scheduling processing unit 140 calculates processing time of each food preparation group 141 arranged into the food preparation scheduling list 142, and when the batch processing time reaches corresponding food preparation batch time, outputs food preparation batch information to the food preparation device for displaying (Step S304). For example, the preparation of one dish of steamed fish needs 7 minutes or the preparation of three dishes of steamed fish together needs 9 minutes, and the time may be predetermined by the system or customized by the user, so as to adjust the processing sequence in the food preparation scheduling list.

The storage module 120 records a food preparation time limit corresponding to each piece of the food ordering data 400; the food preparation time limit may be predetermined by the system or customized by the user, and used to indicate acceptable waiting time of the food ordering data 400, where the waiting time starts from a time point at which the input of the dish data 4020 of the food ordering data 400 is completed to a time point which is calculated by the scheduling processing unit 140 and at which each food preparation group 141 is arranged into the food preparation scheduling list 142. When the waiting time corresponding to the specific food preparation group 141 reaches the food preparation time limit corresponding to the specific food preparation group 141, the system automatically raises the rank of the specific food preparation group 141 arranged in the food preparation scheduling list 142. Referring to FIG. 4B, when waiting time for third dish data 413 of a piece of first food ordering data starting from food ordering time 405 of the first food ordering data 41 to the current time point reaches the set food preparation time limit, the scheduling processing unit 140 adjusts the food preparation scheduling list 142 of the food preparation group 141 to which the third dish data 413 of the current first food ordering data belongs, and the system automatically raises the arrangement rank thereof, so that the food preparation group 141 can be processed preferentially.

The storage module 120 records a maximum limit, corresponding to each piece of the dish data 4020, on a quantity of dishes to be prepared, so as to limit the maximum quantity of specific dish data 4020 that can be processed by each food preparation device 150. The food preparation device 150 makes division according to the category data of the dish data 4020, and can customize categorization according to a cooking process or practice required by the dish data 4020 of the restaurant, such as a food material cleaning area, a seasoning preparation area, a cooking area, and a food serving combination area. When the scheduling processing unit 140 sets up the food preparation group 141, the quantity of the dish data in this food preparation group 141 does not exceed the corresponding maximum limit on the quantity of the dishes to be prepared. When the quantity reaches the maximum limit, the system raises the rank of this food preparation group 141 arranged in the food preparation scheduling list 142, so that this food preparation group 141 can be processed preferentially. When the dish data 4020 of the same category in the food ordering data reaches the maximum limit on the quantity of the dishes to be prepared, the dish data 4020 of the same category is processed preferentially. For example, when at most 5 dishes of fried rice can be prepared at a time, and the quantity of the dish data, namely, the fried rice, of the food ordering data reaches 5, the fried rice is processed preferentially.

The food preparation device 150 includes an execution module, used to invoke the food preparation group 141 ranking the first in the food preparation scheduling list 142 of the food preparation device 150 and execute food preparation. The system can learn, by using the execution module, that the food preparation group 141 ranking the first in the food preparation scheduling list 142 is a food preparation group under food preparation execution, and duration starting from the time at which the food preparation group 141 ranking the first in the food preparation scheduling list 142 is processed to the processing ending time is taken as processing time of this food preparation group. When the food preparation group 141 is arranged in the food preparation scheduling list 142, but does not rank the first, duration from the time point at which the food ordering data is input to the current system time point is taken as waiting time of the food preparation group, and the food preparation group 141 is a food preparation group waiting in a queue. When the execution module completes the preparation of the food preparation group 141 ranking the first and then transmits food serving information out of the system, the execution module invokes the food preparation group 141 ranking the next and executes the corresponding operation, till the food preparation scheduling list 142 is empty.

When the scheduling processing unit 140 determines that the total quantity of the dish data 4020 having the same category data and accumulated in the food preparation group 141 reaches a set value, ranking is performed on the quantity that can be processed by each food preparation device 150 and the time scheduling, so that the system does not need to wait during accumulation of the dish data 4020 having the same category data. In this way, the food preparation group 141 that reaches the set value is preferentially arranged into the food preparation scheduling list 142, or the rank of the food preparation group 141 arranged in the food preparation scheduling list 142 is raised. When the dish data 4020 of the same category in the food ordering data 400 reaches the set value, the dish data 4020 is processed preferentially. For example, the fried rice can be prepared preferentially when its quantity reaches three, so as to avoid that the food preparation device 150 stands by and is idle too long.

When an emergency occurs in the food ordering data 400 transmitted by the food ordering module 110 and received by the scheduling processing unit 140, the scheduling processing unit 140 needs to adjust the food preparation scheduling list 142 after receiving the food ordering data 400 transmitted by the food ordering module 110. For example, when an urgent order is added, in the food preparation scheduling list 142, by using an order number, the urgent order replaces the dish data 4020 of the same category in the original food ordering data 400 that enters the food preparation state or replaces the dish data 4020 of the same category that is to be served according to its rank in the list, that is, the rank of the urgent order is raised in the list and the subsequent orders in the food preparation scheduling list are also adjusted in sequence. In this way, a customer who is about to finish the meal does not need to wait for a long time, and a table turnover rate is enhanced.

When a correction is made to the food ordering data 400 transmitted by the food ordering module 110 and received by the scheduling processing unit 140, the sequence of the updated dish data 4020 in the original food ordering data 400 is adjusted in the food preparation scheduling list 142. In this way, if the updated dish data 4020 still belongs to the food preparation group 141 waiting in a queue, the food preparation group 141 is canceled or corrected; and if the updated dish data 4020 belongs to the food preparation group 141 under preparation, the food ordering data 400 may be canceled or corrected.

The present invention has been disclosed through the foregoing embodiments, but is not intended to be limited thereto. Various variations and equivalent replacements made by persons skilled in the art without departing from the spirit and the scope of the present invention fall within the protection scope of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A restaurant food preparation scheduling management system, comprising:
a food ordering module, used to input food ordering data, wherein each piece of the food ordering data comprises a plurality of pieces of dish data;
a storage module, used to record category data of the dish data;
a categorization module, connected to the storage module and the food ordering module, and used to categorize the dish data in the food ordering data into categories according to the category data;
a scheduling processing unit, used to take the dish data of the same category as a food preparation group according to the category data of the dish data, so as to set up at least one food preparation scheduling list and store the food preparation scheduling list in the storage module; and
at least one food preparation device, each being used to obtain and display the at least one food preparation scheduling list.

2. The restaurant food preparation scheduling management system according to claim 1, wherein the storage module records specific time; the scheduling processing unit makes scheduling batches according to the specific time, and takes the dish data of the same category as the food preparation group according to the category data of the dish data in the food ordering data received within the specific time corresponding to each scheduling batch, so as to set up the at least one food preparation scheduling list, or updates dish data of subsequent food ordering data to the at least one food preparation scheduling list according to the category of the dish data.

3. The restaurant food preparation scheduling management system according to claim 1, wherein the storage module records a food ordering data quantity, which indicates the number of times that the scheduling processing unit receives the food ordering data; when the food ordering data quantity does not reach a set value, the scheduling processing unit takes the dish data of the same category as the food preparation group according to the category of the dish data, so as to set up the at least one food preparation scheduling list, or updates dish data comprised in subsequent food ordering data to the at least one food preparation scheduling list according to the category of the dish data.

4. The restaurant food preparation scheduling management system according to claim 1, wherein the storage module records food preparation batch time corresponding to each piece of the dish data; the food preparation batch time is predetermined by the system or customized by a user, and used to indicate batch processing time corresponding to different quantities of the dish data; and the scheduling processing unit calculates processing time of each food preparation group arranged into the at least one food preparation scheduling list, and when the processing time reaches corresponding food preparation batch time, outputs food preparation batch information to the food preparation device for displaying.

5. The restaurant food preparation scheduling management system according to claim 1, wherein the storage module records a food preparation time limit corresponding to each piece of the food ordering data; and the scheduling processing unit calculates processing time of each food preparation group arranged into the at least one food preparation scheduling list, and when processing time corresponding to a specific food preparation group reaches the food preparation time limit corresponding to the specific food preparation group, raises the rank of the specific food preparation group arranged in the at least one food preparation scheduling list.

6. The restaurant food preparation scheduling management system according to claim 1, wherein the storage module records a maximum limit, corresponding to each piece of the dish data, on a quantity of dishes to be prepared, and when the scheduling processing unit sets up each food preparation group, the quantity of the dish data in the food preparation group does not exceed the corresponding maximum limit on the quantity of the dishes to be prepared.

7. The restaurant food preparation scheduling management system according to claim 1, wherein when determining that a total quantity of the dish data having the same category data in a specific food preparation group reaches a set value, the scheduling processing unit preferentially arranges the specific food preparation group into the at least one food preparation scheduling list, or raises the rank of the specific food preparation group arranged in the at least one food preparation scheduling list.

8. The restaurant food preparation scheduling management system according to claim 1, wherein the food preparation device further comprises an execution module, used to invoke the food preparation group ranking the first in the food preparation scheduling list of the food preparation device and execute food preparation.

9. A restaurant food preparation scheduling management method, comprising:
inputting, by a food ordering module, food ordering data, wherein each piece of the food ordering data comprises a plurality of pieces of dish data;
categorizing, by a categorization module, the dish data in the food ordering data into categories according to category data recorded in a storage module;
taking, by a scheduling processing unit, the dish data of the same category as a food preparation group according to the category data of the dish data, so as to set up at least one food preparation scheduling list; and
obtaining and displaying, by at least one food preparation device, the at least one food preparation scheduling list.

10. The restaurant food preparation scheduling management method according to claim 9, wherein the step of taking, by a scheduling processing unit, the dish data of the same category as a food preparation group according to the category data of the dish data, so as to set up at least one food preparation scheduling list comprises:
making, by the scheduling processing unit, scheduling batches according to the specific time, and taking the dish data of the same category as the food preparation group according to the category data of the dish data in the food ordering data received within the specific time corresponding to each scheduling batch, so as to set up the at least one food preparation scheduling list.

11. The restaurant food preparation scheduling management method according to claim 10, wherein after the step of taking, by a scheduling processing unit, the dish data of the same category as a food preparation group according to the category data of the dish data, so as to set up at least one food preparation scheduling list, the method further comprises:
updating, by the scheduling processing unit, dish data comprised in subsequent food ordering data to the at least one food preparation scheduling list according to category data of the dish data within the specific time in the same scheduling batch.

12. The restaurant food preparation scheduling management method according to claim 9, wherein the step of taking, by a scheduling processing unit, the dish data of the same category as a food preparation group according to the category data of the dish data, so as to set up at least one food preparation scheduling list further comprises:
when the number of times that the scheduling processing unit receives the food ordering data does not reach a set value of a food ordering data quantity, taking, by the scheduling processing unit, the dish data of the same category as the food preparation group according to the category of the dish data, so as to set up the at least one food preparation scheduling list.

13. The restaurant food preparation scheduling management method according to claim 11, wherein after the step of taking, by a scheduling processing unit, the dish data of the same category as a food preparation group according to the category data of the dish data, so as to set up at least one food preparation scheduling list, the method further comprises:
when the number of times that the scheduling processing unit receives the food ordering data does not reach a set value of a food ordering data quantity, updating dish data comprised in subsequent food ordering data to the at least one food preparation scheduling list according to category data of the dish data.

14. The restaurant food preparation scheduling management method according to claim 11, wherein after the step of taking, by a scheduling processing unit, the dish data of the same category as a food preparation group according to the category data of the dish data, so as to set up at least one food preparation scheduling list, the method further comprises:
calculating, by the scheduling processing unit, processing time of each food preparation group arranged into the at least one food preparation scheduling list; and
when the scheduling processing unit determines that processing time corresponding to a specific food preparation group reaches a food preparation time limit corresponding to the target food preparation group, raising the rank of the target food preparation group arranged in the at least one food preparation scheduling list.
